(19) United States
(12) Patent Application Publication
(10) Pub. No.: US 2015/0205628 A1
(43) Pub. Date: Jul. 23, 2015

(54) Embedding Content in Java Archives

(71) Applicant: Matthew Millar, Oxfordshire (GB)

(72) Inventor: Matthew Millar, Oxfordshire (GB)

(73) Assignee: Adobe Systems Incorporated

(21) Appl. No.: 11/937,443

(22) Filed: Nov. 8, 2007

Related U.S. Application Data
(60) Provisional application No. 60/976,170, filed on Sep. 28, 2007.

(51) Int. Cl. G06F 9/455

(52) U.S. Cl. CPC G06F 9/45558; G06F 17/30073; G06F 2009/45583

(57) ABSTRACT

The present disclosure includes, among other things, systems, methods and program products for embedding content in Java archives.

### CROSS-REFERENCE TO RELATED APPLICATIONS

This application claims priority to pending U.S. Provisional Application Ser. No. 60/976,170, filed Sep. 28, 2007, the entire contents of which are hereby incorporated by reference.

### BACKGROUND

Some mobile phones come with a Java Virtual Machine (JVM) pre-installed and integrated into the mobile phone's operating system. A JVM is an execution environment for programs written in the Java programming language. A Java program is typically distributed as a Java Archive (JAR) which is a compressed file that aggregates the program's class files and other information needed by the program such as metadata. Some mobile phone operating systems natively recognize JAR files. For example, if a user selects a JAR file for invocation through a mobile phone's graphical user interface, the phone's operating system will automatically launch a JVM to execute the program contained in the JAR. This seamless functionality makes it attractive to develop games and other applications for mobile phones in Java since programs or content requiring an execution environment other than a JVM typically lack such integration.

### SUMMARY

In general, one or more aspects of the subject matter described in this specification can be embodied in one or more methods that include identifying a program in a Java Archive (JAR). The program is invoked where the program performs the following steps: 1) identifying content in the JAR; 2) persisting the content outside of the JAR; and 3) invoking a content player to process the content. Other embodiments of this aspect include corresponding systems, apparatus, and computer program products.

These and other embodiments can optionally include one or more of the following features. Persisting can comprise saving the content in a file or a memory. The content can include code. The code can be executed by a content player. The content player can be a Flash content player.

In general, one or more aspects of the subject matter described in this specification can be embodied in one or more methods that include identifying a method for a class in a Java Archive (JAR). The method is invoked where the methods performs the following steps: 1) identifying Flash content in the JAR; 2) persisting the content outside of the JAR; and 3) invoking a content player to process the content.

These and other embodiments can optionally include one or more of the following features. Persisting can comprise saving the content in a file or a memory. The content can include code. The code can be executed by a content player. The content player can be a Flash content player.

In general, one or more aspects of the subject matter described in this specification can be embodied in a system comprising a first virtual machine which is operable to invoke a method for a class in a Java Archive (JAR). The method is operable to identify content in the JAR, persist the content outside of the JAR, and invoke a second distinct virtual machine to process the content. The second virtual machine is operable to process the content.

These and other embodiments can optionally include one or more of the following features. Persisting can comprise saving the content in a file or a memory. The content can include code. The second virtual machine can be operable to execute the code. The content can be Flash.

Particular embodiments of the subject matter described in this specification can be implemented to realize one or more of the following advantages. Running Flash content on devices is as easy as running Java applications, and without requiring the Flash player to be integrated into an underlying operating system. Any type of content can be distributed in a JAR file and launched by a mobile phone's native JVM.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 illustrates an example system for extracting embedded content from a JAR (Java Archive) file.

FIG. 2 is a flowchart of an example technique for invoking a content player to process embedded content.

FIG. 3 illustrates an example system for invoking a content player to process embedded content.

FIG. 4 shows example Java code instructions for invoking a content player to process embedded content.

FIG. 5 is a block diagram of generic computing devices. Like reference numbers and designations in the various drawings indicate like elements.

### DETAILED DESCRIPTION

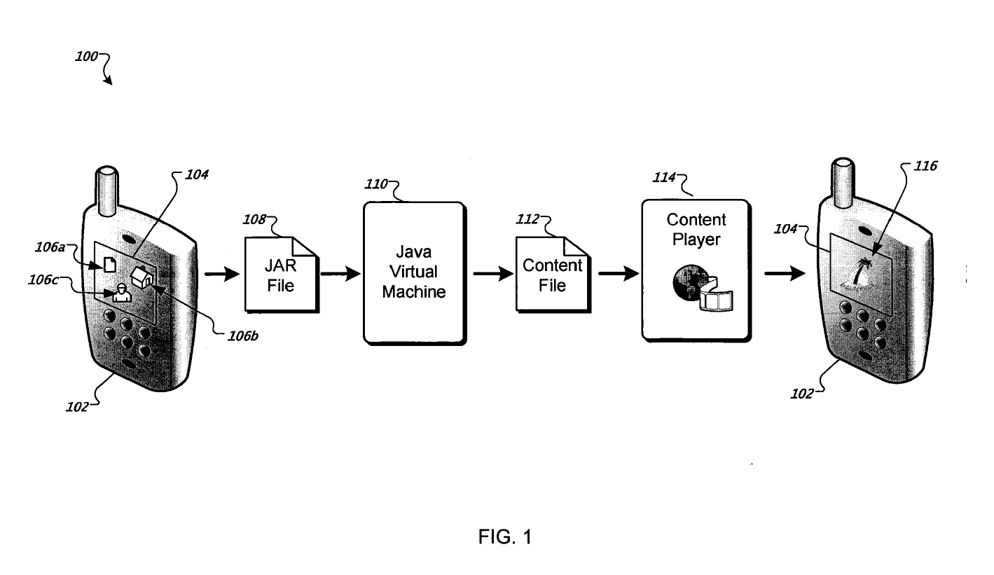

FIG. 1 illustrates an example system 100 for extracting content from a JAR (Java Archive) file. In various implementations, the content is an Adobe Flash SWF file or a alternate representation of such. The Flash file format SWF was created by Adobe Systems Incorporated of San Jose, California. Flash content can contain vector graphics, audio, video, animations, ActionScript applications, other content. When executed, Flash content can provide varying levels of user interactivity. Other types of content beside Flash are possible. The system 100 includes a device 102. In various implementations, the device 102 is a mobile phone, smart phone, personal digital assistant (PDA), Blackberry device, laptop computer, Pocket PC, electronic gaming device, media player, personal computer, workstation, server or combinations of these. Other types of devices are possible. The device 102 includes a display 104 which can be integrated with the device 102 or separate from the device 102. The device 102 can also include, for example, integrated or separate speakers for outputting sound, user input devices such as buttons, a keypad, a mouse or joystick, a touch-sensitive display 104, a microphone, and an accelerometer for determining the orientation of the device 102.

The display 104 can present a graphical user interface (GUI) for applications which run on the device 102. The graphical user interface can present one or more display objects (e.g., icons) 106a-c. In the example shown, the display objects 106a-c are graphic representations of applications which can be executed by the user such as personal information management applications (e.g., address book, calendar, electronic mail), games, media players, and other types of applications. The display objects 106a-c can also represent types of data or information stored on the device 102 such as JAR files, call logs, and content such as movies. In various implementations, user selection of a display object representing a JAR file (e.g., 106a) results in the JAR file 108 being automatically provided to a JVM 110 or other program capable of executing Java code. Alternatively, a user can launch the JVM 110 manually (e.g., by selecting a JVM display object) and commanding the JVM 100 to load the JAR file 108. In a further alternative, a process running on the device 102 can launch JVM 110 and have it load the JAR file 108.

The JAR file 108 has an optional manifest file whose entries determine how the JAR file will be used, such as by identifying a start-up Java program within the JAR file 108 for the NM 100 to execute after the JAR file 108 is loaded. The JVM 110 locates and executes the start-up program. The start-up program extracts one or more content files 112 from the JAR file and invokes a content player 114 to process the content file(s) 112. In various implementations, the content 112 is Flash or content that is compatible with Flash. In other implementations, the content 112 is any information that can be processed by a program invoked by the start-up program. By processing the content 112, the content player 114 can cause the device 102 to present a rendering of the content on the display 104, for example. In various implementations, the content player is the Adobe Flash Player available from Adobe Systems Incorporated, or other player capable of interpreting Flash content such as Gnash, available from GNU. Other content players are possible including, for example, Microsoft Silverlight, available from Microsoft Corporation.

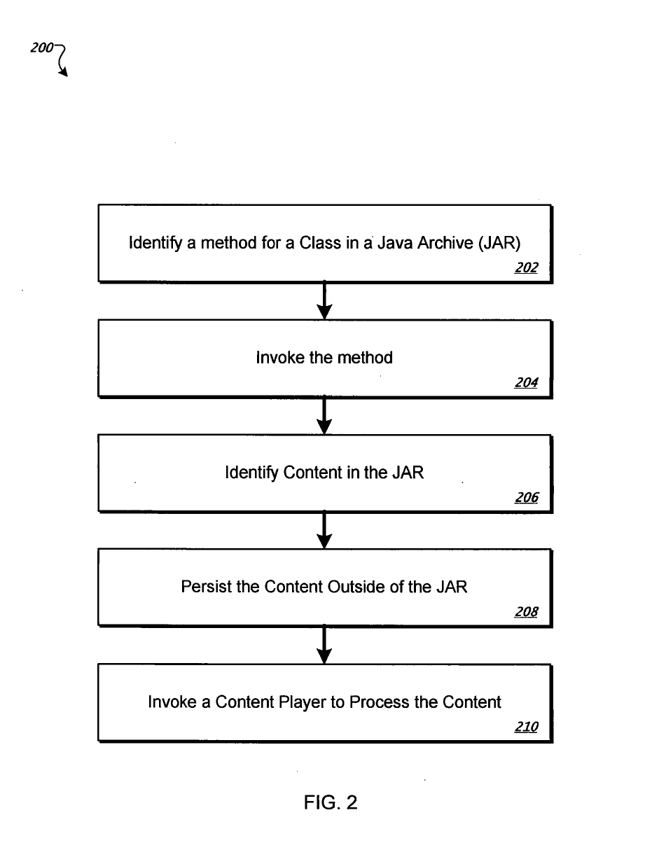

FIG. 2 is a flowchart of an example method 200 for invoking a content player to process embedded content which summarizes the activities illustrated in FIG. 1. First, a program is identified in a JAR (e.g., 108; step 202). The program is then invoked by a JVM (e.g., 110; step 204). The executing program (e.g., Java program) extracts embedded content from the JAR (e.g., 108) and persists the content (e.g., 112) outside of the JAR (e.g., in a separate file on the device 102; step 208). The executing program then invokes a content player (e.g., 114) to process the content (step 210). The content player can execute code (e.g., ActionScript code) as part of the processing of the content. Content processing can also include an audiovisual presentation.

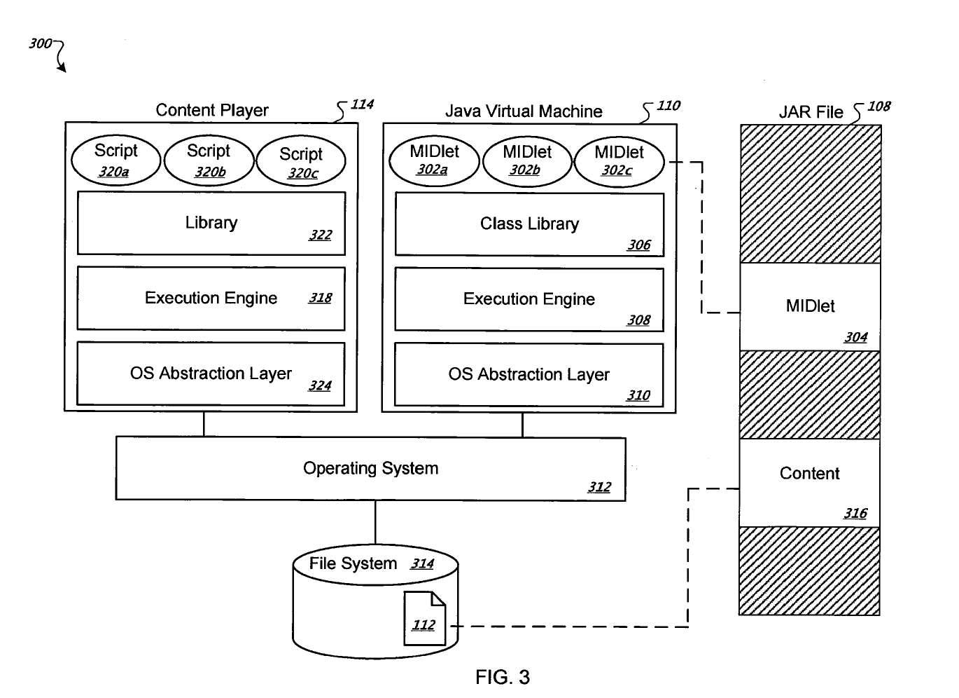

FIG. 3 is an example system diagram 300 for invoking a content player to process embedded content on a device. A JVM 110 can execute one or more MIDlet programs 302a-c. A MIDlet is a Java program coded to run in the Java ME (Micro Edition) virtual machine. A virtual machine creates a runtime environment for executing software on an abstract machine, rather than a specific microprocessor architecture, for example. Alternatively, the JVM 110 can execute other types of Java programs such as applets or servlets. The JAR file 108 can include a program 304 (e.g., a MIDlet) to be loaded into the JVM 110 (e.g., as MIDlet 302c). The JVM 110 has a class library 306 that includes class definitions of common services used by one or more of the MIDlets 302a-c, including any class definitions loaded from the JAR file 108. An execution engine 308 executes code for the MIDlets.

The MIDlets 302a-c can use an operating system (OS) abstraction layer 310 to access functionality of an underlying operating system 312 of the device 102, such as video Input/Output (I/O), sound I/O, file system I/O, network I/O, and the ability to execute programs on the device 102. An abstraction layer 310 hides the differences in underlying operating systems 312 from the MIDlets 302a-c and class libraries. By way of illustration, the MIDlet 302c can use the class library 306 to instantiate a file class to write the content 316 to a file 112 on the device 102's file system. The file class, in turn, can utilize the abstraction layer 310 to instruct the operating system 312 to create the content file 112 in the file system 314. By way of further illustration, the MIDlet 302c can invoke a function provided by the abstraction layer 310 to cause the operating system 312 to invoke the content player 114 and provide it with the content file 112 as a run-time parameter.

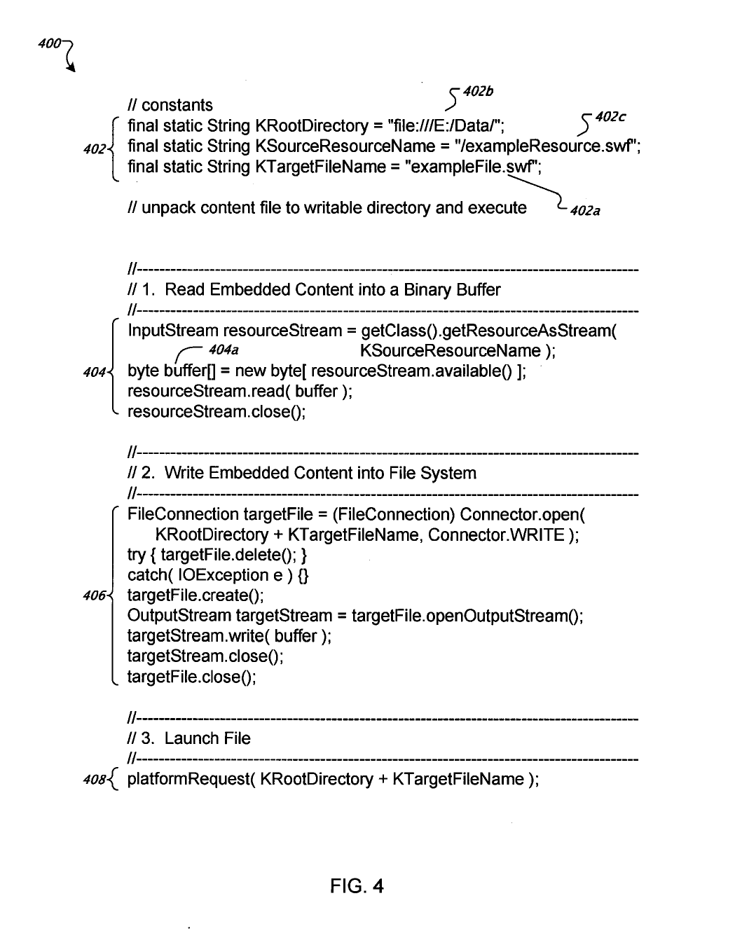

The content player 114 can execute one or more portions of code or scripts (e.g., 320a-c). In various implementations, the scripts are ActionScript scripts. ActionScript is a scripting language based on ECMAScript which was standardized by Ecma International in the ECMA-262 specification. ActionScript includes functionality for implementing rich multimedia applications. The content player 114 has a library 322 that includes functionality for common services used by scripts 320a-c. An execution engine 318 executes code for the scripts 320a-c. The scripts 320a-c and the library 322 can use an operating system (OS) abstraction layer 324 to access functionality of the operating system 312, similar to the JVM 110 abstraction layer 310. By way of illustration, the script 320a can use a function in the library 322 to read the contents of the content file 112 from the file system 314. FIG. 4 shows example Java code instructions 400 for invoking a content player to process embedded content. The instructions 402 can be included in a Java MIDlet class in a JAR file (e.g., 108) executable upon user selection of the JAR file 108 in a GUI. The instructions 402 identify a file name 402a, a directory name 402b, and a resource name 402c. The file name 402a and directory name 402b are used for persisting content extracted from the JAR file 108. The resource name 402c corresponds to the name of the content included in the JAR file 108.

Instructions 404 read content from the JAR file 108 into a memory buffer 404a. Instructions 406 write the contents of the memory buffer 404a to a file (e.g., content file 112) in the file system 314, where the file is identified by a combination of the directory name 402b and the file name 402a. Instruction 408 invokes the content player (e.g., 114) to process the content stored in the content file 112. The “platformRequest” instruction 408 is configured to launch a particular content player (e.g., an Adobe Flash Player). The content player 114 will read the content file 112, execute code (e.g., ActionScript in content 112), and render the content.

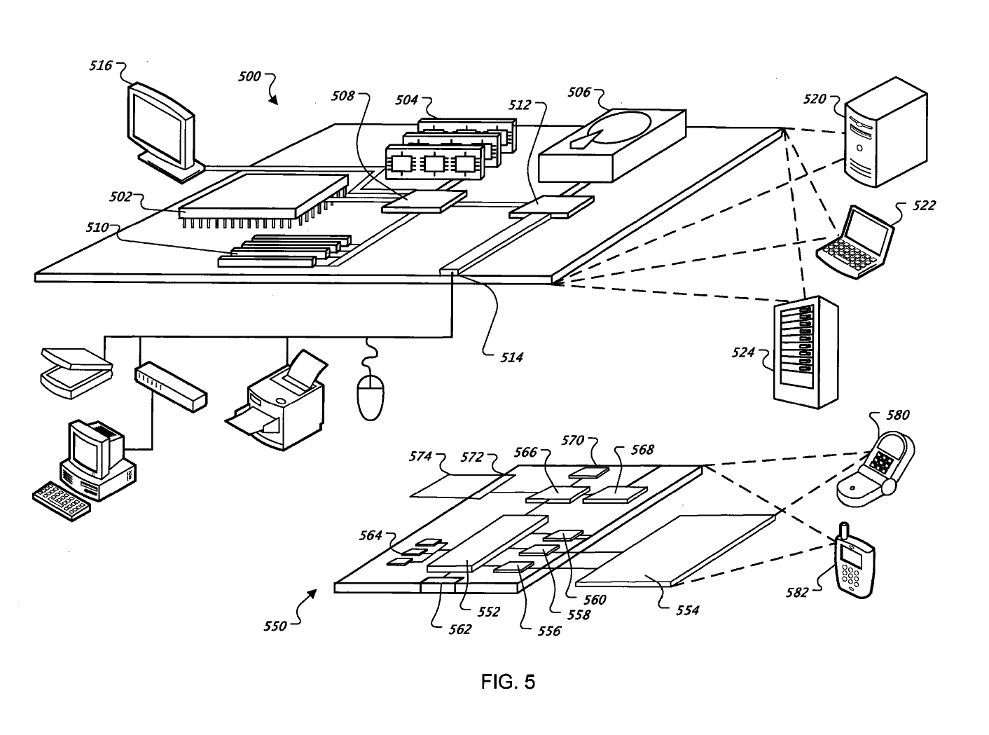

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of devices, such as personal digital assistants, cellular telephones, smartphones, and other similar computing devices. The components shown here, their connections and relationships, and their functions, are meant to be examples, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods or implement one or more systems, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of duties is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550.

Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods or implement one or more systems, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as

GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communication audibly using audio codec 560, which may receive spoken information from a user and convert it to usable digital information. Audio codex 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in FIG. 5. For example, it may be implemented as a cellular telephone 580. It may also be implemented as part of a smartphone 582, personal digital assistant, or other similar device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A computer-implemented method comprising:
receiving a Java Archive (JAR) that contains content and a program executable by a virtual machine;
identifying the program contained in the JAR;
invoking the program where the program performs the following operations when executed by the virtual machine:
identifying the content in the JAR;
persisting the content outside of the JAR; and
invoking a content player to process the content.

2. The method of claim 1 where persisting comprises saving the content in a file or a memory.

3. The method of claim 1 where the content includes code.

4. The method of claim 3, further comprising:
executing the code by the content player.

5. The method of claim 1 where the content player is a Flash content player.

6. A computer program product, encoded on a computer-readable medium, operable to cause data processing apparatus to perform operations comprising:
receiving a Java Archive (JAR) that contains content and a program executable by a virtual machine;
identifying the program contained in the JAR;
invoking the program where the program performs the following operations when executed by the virtual machine:
identifying the content in the JAR;
persisting the content outside of the JAR; and
invoking a content player to process the content.

7. The product of claim 6 where persisting comprises saving the content in a file or a memory.

8. The product of claim 6 where the content includes code.

9. The product of claim 8, further comprising:
executing the code by the content player.

10. The product of claim 6 where the content player is a Flash content player.

11. A computer-implemented method comprising:
receiving a Java Archive (JAR);
identifying a method for a class in the JAR
invoking the method where the method performs the following operations when executed by a virtual machine:
identifying content in the JAR;
persisting the content outside of the JAR; and
invoking a content player to process the content.

12. The method of claim 11 where persisting comprises saving the content in a file or a memory.

13. The method of claim 11 where the content includes code.

14. The method of claim 13, further comprising:
executing the code by the content player.

15. A computer program product, encoded on a computer-readable medium, operable to cause data processing apparatus to perform operations comprising:
receiving a Java Archive (JAR);
identifying a method for a class in the JAR;
invoking the method where the method performs the following operations when executed by a virtual machine:
identifying content in the JAR;
persisting the content outside of the JAR; and
invoking a content player to process the content.

16. The product of claim 15 where persisting comprises saving the content in a file or a memory.

17. The product of claim 15 where the content includes code.

18. The product of claim 17, further comprising:
executing the code by the content player.

19. A system comprising:
data processing apparatus operable to execute a first virtual machine installed on a computing device and a second virtual machine installed on the computing device;
the first virtual machine operable to invoke a method for a class in a Java Archive (JAR);
the method is operable to identify content in the JAR, persist the content outside of the JAR, and invoke a second distinct virtual machine to process the content; and
the second virtual machine operable to process the content.

20. The system of claim 19 where persisting comprises saving the content in a file or a memory.

21. The system of claim 19 where the content includes code.

22. The system of claim 21 where the second virtual machine is operable to execute the code.

23. The system of claim 19 where the content is Flash.

24. The method of claim 1 where the virtual machine is Java Virtual Machine.
